(19) United States
(12) Patent Application Publication
(10) Pub. No.: US 2010/0223563 A1
(43) Pub. Date: Sep. 2, 2010

(54) REMOTELY DEFINING A USER INTERFACE FOR A HANDHELD DEVICE

(75) Inventor: James Green, San Jose, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(73) Assignee: Apple Inc., Cupertino, CA (US)

(21) Appl. No.: 12/434,470

(22) Filed: May 1, 2009

Related U.S. Application Data
(60) Provisional application No. 61/156,875, filed on Mar. 2, 2009.

(51) Int. Cl. G06F 3/00; G06F 15/177

(52) U.S. Cl. 715/762; 709/221

(57) ABSTRACT

In some embodiments, a host computer can be used by a user to arrange icons among a plurality of home screens or views. For example, a representation of each of the home screens available at a handheld device can be displayed on a host computer along with a representation of the available icons usable at the handheld device. A user can select representation of icons at the host computer and arrange the icons among the representations of the home screens. Icons and/or home screens can be added and/or removed. The arrangement created by the user at the host computer display can be sent to the handheld device when completed.

### CROSS-REFERENCES TO RELATED APPLICATIONS

This application claims the benefit of commonly assigned U.S. Provisional Patent Application No. 61/156,875, filed Mar. 2, 2009, entitled “Remotely Defining a User Interface for a Portable Device,” the disclosure of which is herein incorporated by reference for all purposes.

### BACKGROUND

Handheld devices such as PDAs, smartphones, and watches have become ubiquitous. These devices are equipped with various graphical user interfaces that can display an arrangement of objects representing applications, documents, media, etc. on one or more views of a mobile computing device. Views can display an arrangement of objects or icons on a display of a mobile computing device to a user for their selection. When an object is selected, the application can be executed, the document can be opened, the media can be displayed, etc. A number of views can be used to arrange a large number of icons for selection by a user.

### BRIEF SUMMARY

In some embodiments of the invention, a host computer can be used by a user to manage the arrangement of one or more objects for a handheld device such as a mobile computing device. For example, a representation of each of the views available at a handheld device can be displayed on a host computer along with a representation of the available icons usable at the handheld device. A user can select a representation of icons at the host computer and arrange the icons among the representations of the views. Representations of icons and/or views can be added and/or removed. The arrangement created by the user at the host computer display can be sent to the handheld device when completed.

The following detailed description together with the accompanying drawings will provide a better understanding of the nature and advantages of the present invention.

### BRIEF DESCRIPTION OF THE DRAWINGS

FIG. 1 shows a handheld device coupled with a host computer using a wired or wireless connection according to various embodiments of the invention.

FIG. 2 shows three views of a handheld device displaying a different view on each view according to some embodiments of the invention.

FIG. 3 shows a representation of the three views shown in FIG. 2 on the display of a host computer according to some embodiments of the invention.

FIG. 4 shows an icon being moved from representation of a view of the handheld device to a representation of another view on the display of a host computer according to some embodiments of the invention.

FIG. 5 shows the icon that was shown being moved from one representation of a view to another in FIG. 4 placed on the other view according to some embodiments of the invention.

FIG. 6 shows a number of icons prepared for placement on a representation of a single view according to some embodiments of the invention.

FIG. 7 shows some of the icons prepared for placement on a representation of a single view placed on the representation of a single view according to some embodiments of the invention.

FIG. 8 shows a representation of second view with icons placed thereon according to some embodiments of the invention.

FIG. 9 provides a schematic representation of a computer system that can be used to implement various embodiments of the invention.

FIG. 10 provides a schematic representation of a handheld device that can be used to implement various embodiments of the invention.

FIG. 11 shows a flowchart of a process for organizing objects on a secondary home screen or home screens using a host computer according to some embodiments of the invention.

FIG. 12 shows a flowchart of a process for a handheld device to receive organized home screen or home screens from a host computer according to some embodiments of the invention.

### DETAILED DESCRIPTION

Certain embodiments of the invention disclosed herein provide a user of a handheld device the ability to organize objects displayable on one or more views of a handheld device using a host computer. For example, icons displayed on more than one views can be arranged using the host computer by displaying a representation of the one or more views and allowing a user to move icons within a view, move objects between views, remove icons, add icons, and/or add views.

As used throughout this disclosure, the term “view” is used to a describe a grouping of objects that is displayable on a display of a computing device at a single time. A view, for example, can include a home screen, screen, page, pane, desktop, and/or overlay. As used throughout this disclosure the term “object” includes content, icons, applications, files, folders, text boxes, buttons, graphics, media objects, and/or user interface elements that can be displayed on a view of a computing device.

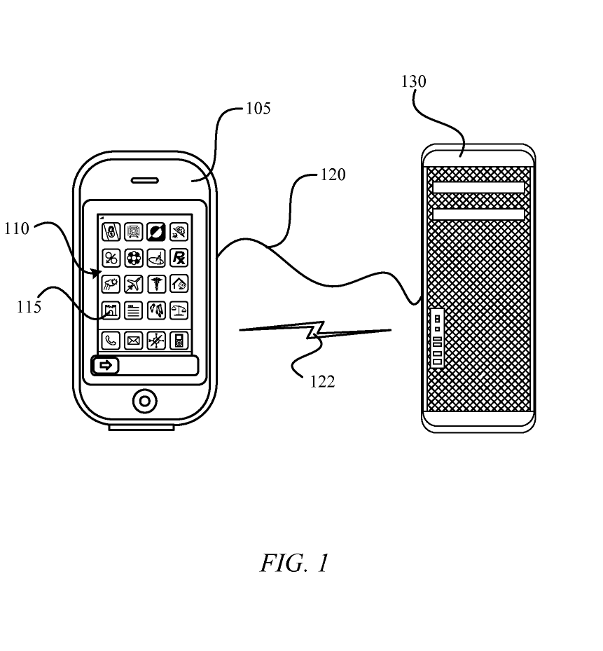

FIG. 1 shows a handheld device 105 communicatively coupled with host computer 130. Handheld device 105 can be any type of computing device. For example, handheld device 105 can be a smart phone, a mobile computing device, a mobile phone, a portable media player, a watch, etc. Handheld device 105 can include one or more views that can be displayed on display 110. A view can include one or more objects 115 that can be graphically displayed on the view. Multiple views can be provided, but in some embodiments, a user can only observe one view on display 110 at a time. Controls such a touchpad, pointer, scroll ball, button, or touch screen can allow the user to switch between different views. Objects 115 can include icons, text boxes, buttons, graphics, media objects, menus, widgets, user interface elements, etc. In some embodiments, the objects can graphically represent a file, a folder, an application, or a device that can be opened, executed or accessed by selecting the object using the handheld device's graphical user interface or other user interface. Host computer 130 can be a computing device such as a laptop, desktop, server, network, and/or cloud computer system or the like. In some embodiments, host computer 130 can provide a larger display than handheld device 105.

Signals can be communicated between handheld device 105 and host computer 130 using any wired and/or wireless communications protocol or set of protocols. FIG. 1 shows both wired connection 120 and wireless connection 122. In some embodiments, wired connection 120 may be used. In other embodiments of the invention wireless connection 122 may be used. Moreover, a handheld device 105 and/or a host computer 130, in some embodiments, can be equipped with either a wired connection 120, a wireless connection 122, and/or both. Wired connection 120 can be connector-to-connector or can use intervening cables. Wireless connection 122 can include a Bluetooth connection, a WiFi connection, a 3G connection, a cell phone connection, a wireless personal area network connection, an infrared connection, an acoustic connection, etc. Any number of communication paths can be used. Paths can be separate paths or various subsets can be multiplexed onto a common path. Different embodiments can have fewer or more signal paths. In some embodiments, the set of communication paths can be provided by a multi-pin connector. In some embodiments, some signals can have dedicated pins and others can share one or more pins.

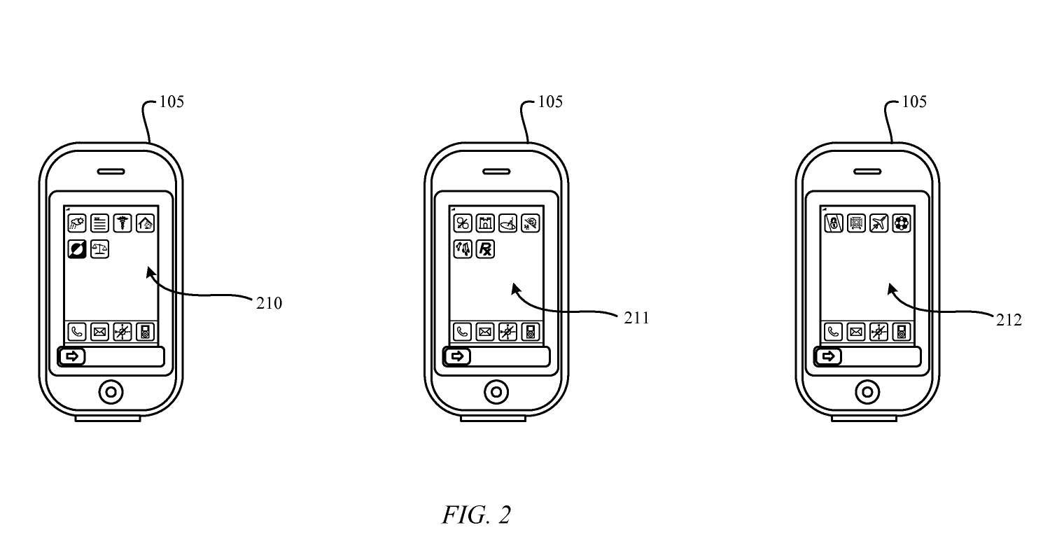

FIG. 2 shows three perspectives of handheld device 105, each displaying a different view, according to some embodiments of the invention. As shown, each view 210, 211, 212 displays a group of objects. In some embodiments, each view displays a different group of objects. In some embodiments, different views can display one or more of the same object. A user can switch between views to access an object displayed on a specific view.

A user, for example, may wish to arrange a group of similar objects together on one view and a different group of objects on another view. Some handheld devices can allow a user to move objects within a view or from one view to another view. Some handheld devices, for example, can allow a user to invoke an “edit mode” that allows the user to arrange objects on one or more views. For example, the user can invoke “edit mode”, select an object on a view, and move the object to a new position on the view or to a position on another view using a trackball, buttons, a touch screen a touch pad, etc.

Some handheld devices only allow a user to observe a single view at any one time. To move, for example, an object from one view to another view, the user can drag the object and move it from one view to another using any of various handheld controls. In doing so, the user may have to move from view to another view. As the number of views increase, the challenge of arranging objects among the views becomes more difficult as the user may have to drag an object across multiple views.

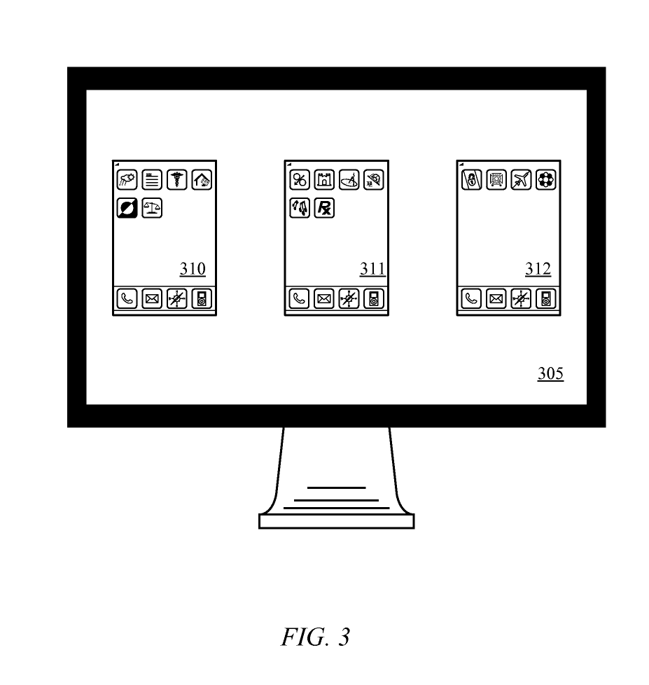

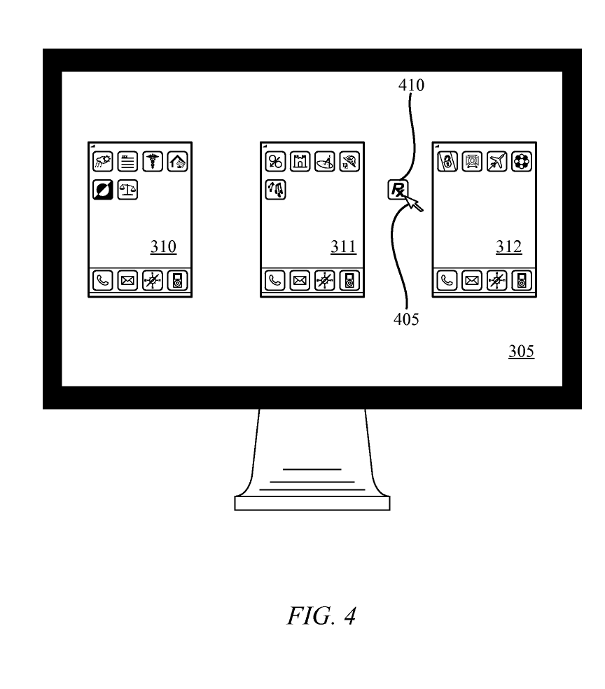

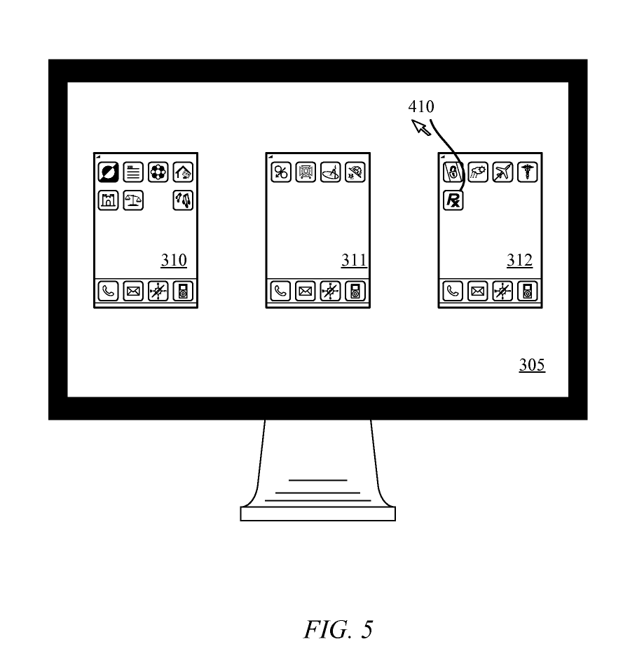

FIG. 3 shows the three views 210, 211, 212 shown on the handheld device in FIG. 2, as three view representations 310, 311, 312 on display 305 of a host computer according to some embodiments. In some embodiments, view representations 310, 311, 312 can be displayable at the same time on a host computer, while views 210, 211, 212 on handheld device 105 are not displayable at the same time. In some embodiments, view representations 310, 311, 312 can be displayed using a host computer (e.g., host computer 130 of FIG. 1) when the handheld device is coupled with the host computer. In some embodiments, information regarding objects and views for a handheld device can be saved at the host computer. In such embodiments, the host computer can display view representations without being coupled with a handheld device. The objects shown on the three view representations 310, 311, 312 can be moved from one view representation to another view representation as shown in FIG. 4 and FIG. 5.

FIG. 4 shows object 410 on view representation 311 being moved to view representation 312 using cursor 405. Cursor 405, for example, can be operated by a user of the host computer to select object 410 on view representation 311 and drag the object to view representation 312 (e.g., using a mouse, touch pad, touch screen, or other user input device). Object 410 is shown on view representation 312 in FIG. 5. Accordingly, a user can arrange objects within a view representation or between view representations on a host computer, and an indication of this arrangement can be sent to the handheld device. The handheld device can then display each of the views according to the arrangement received from the host computer. While a single object is shown being moved from one view representation to another view representation, more than one object can be moved from view representation to view representation. In some embodiments, an object can be moved from one location on a view representation to another location on the same view representation.

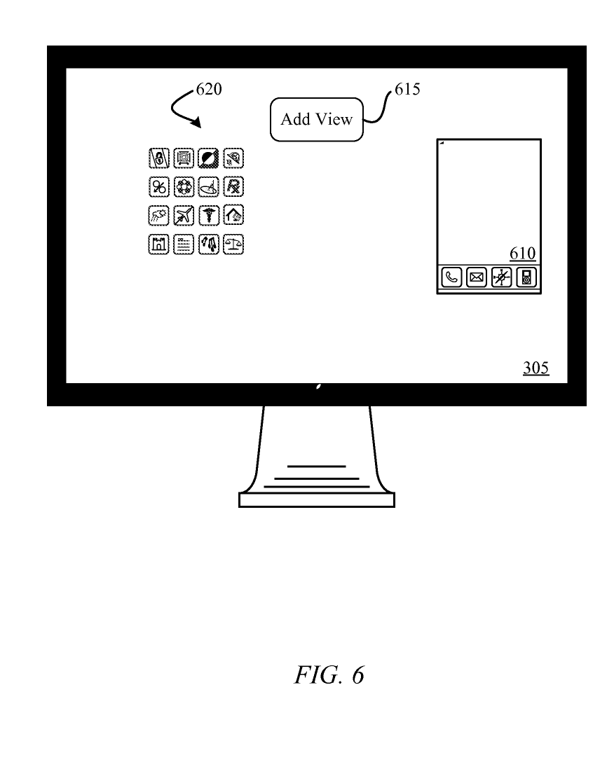

In other embodiments, a user can use a host computer to place an object on one or more views of a secondary device. For example, FIG. 6 shows a set of objects 620 prepared for placement on first view representation 610 on display 305 of a host computer, according to some embodiments. In some embodiments, some or all of the set of objects 620 can be icons, an indication of the objects available for display on views can be received from a handheld device. In some embodiments, some or all of the set of objects 620 can be icons representing applications or files downloaded from an application store and/or media store for use on the handheld device. In some embodiments, objects 620 can comprise the complete set of objects or icons that can be displayed on any host screen of the handheld device. Display 305 can also include a first view representation 610 that represents a first view of a handheld device.

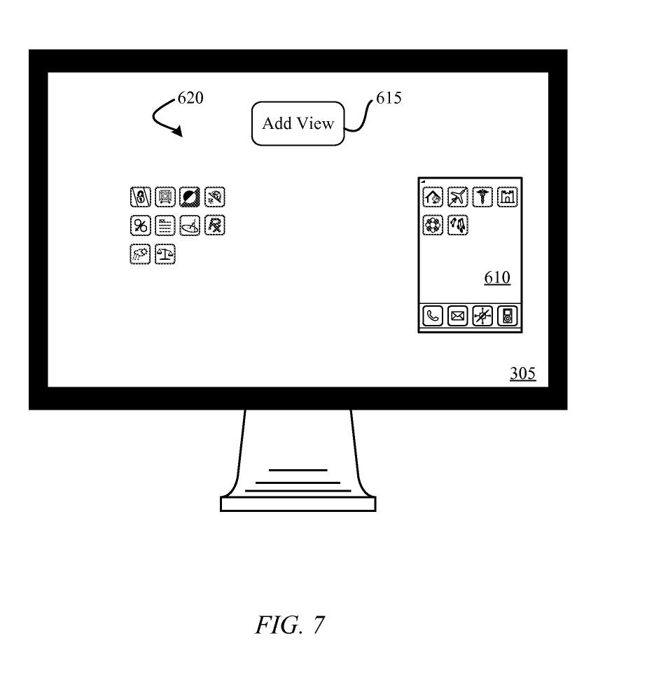

FIG. 7 shows some of the set of objects 620 shown in FIG. 6, placed on first view representation 610 on display 305 of the host computer according to some embodiments. For example, a user can drag and drop objects from the set of objects 620 on display 305 using a pointer device, such as a mouse. A single object or a group of objects can be selected, dragged and dropped at any representation of a view. Any other user interface can be used to place the icons on first view representation 610. For example, the display can be a touch screen, and the user can simply touch an object on the display and drag it to the view representation.

In some embodiments, the objects can be arranged within first view representation 610. In some embodiments, objects can be placed within a predefined pattern. For example, a predefined pattern can include an alphabetic arrangement, an arrangement by object type, an arrangement by functional type, an arrangement based on orthogonal coordinates, etc. In some embodiments, objects can be placed anywhere within the first view. In some embodiments, objects can snap to predefined locations. That is, if an object is placed near a predefined location, the object can be automatically placed at the predefined location. When the user has arranged the objects as desired, an indication of the objects location can be sent from the host computer to the handheld device.

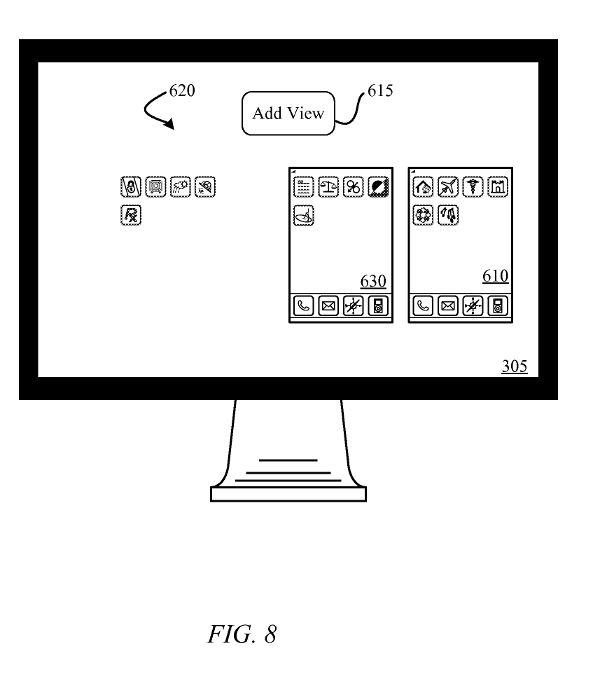

If a user desires to place some of the set of objects 620 on a second view, the user can, for example, select add view button 615 to create a new view representation. FIG. 8 shows a representation of second view 630 with icons placed thereon according to some embodiments. Thus, a user can drag and drop objects from the set of objects 620 to a representation of more than one view. When the user has arranged the objects as desired, an indication of the object's location on each of the views configured by the user can be sent from the host computer to the handheld device.

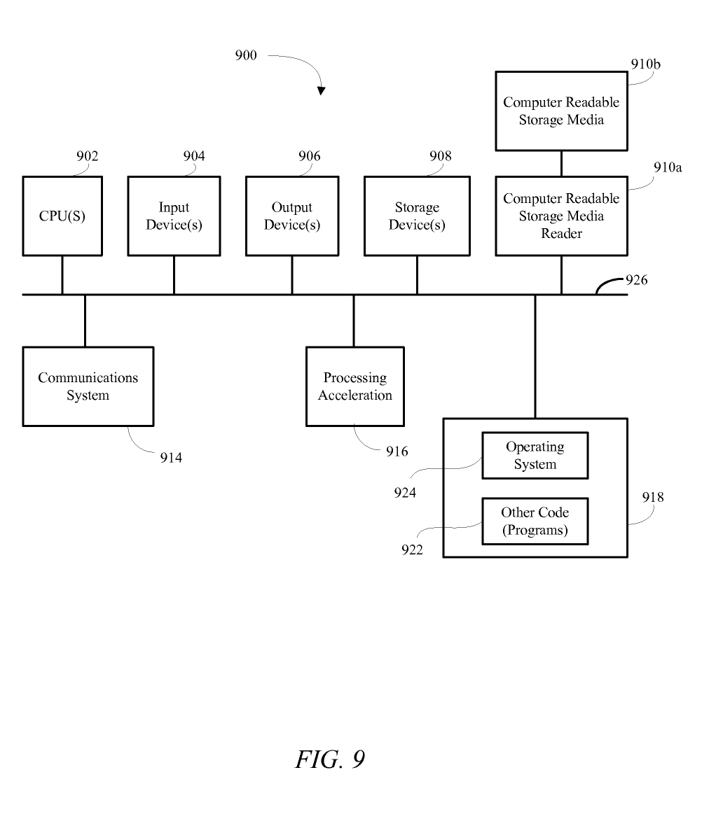

A host computer can be a computational device 900 like that shown schematically in FIG. 9. The drawing broadly illustrates how individual system elements can be implemented in a separated or more integrated manner. The computational device 900 is shown comprised of hardware elements that are electrically coupled via bus 926. The hardware elements include processor 902, input device 904, output device 906, storage device 908, computer-readable storage media reader 910a, communications system 914, processing acceleration unit 916 such as a DSP or special-purpose processor, and memory 918. The computer-readable storage media reader 910a is further connected to a computer-readable storage medium 910b, the combination comprehensively representing remote, local, fixed, and/or removable media devices plus storage media readers for temporarily and/or more permanently containing computer-readable information. The communications system 914 can comprise a wired, wireless, modem, and/or other type of interfacing connection and can permit data to be exchanged with external devices, such as, a handheld device.

In some embodiments, input device 904 and output device 906 can be a single device, for example, a USB interface. In some embodiments, input device 904 and/or output device 906 can be used to connect the host computer with a handheld device. In some embodiments, input device 904 can be used to receive input from a pointing device such as a mouse, touch screen, touch pad, track ball, etc., and output device 906 can include a visual output device such as a display.

The computational device 900 also comprises software elements, shown as being currently located memory 918, including an operating system 924 and other code 922, such as a program designed to implement methods described herein. It will be apparent to those skilled in the art that substantial variations can be used in accordance with specific requirements. For example, customized hardware might also be used and/or particular elements might be implemented in hardware, software (including portable software, such as applets), or both. Further, connection to other computing devices such as network input/output devices can be employed.

Software elements can also include software enabling execution of embodiments disclosed throughout this disclosure. For example, software can be stored in working memory 920, that receives home screen and home screen object information from a handheld device, displays home screen representations and/or objects on a display, and allows a user to manipulate the arrangement of objects on one or more home screen representations. The software can also send an indication of the arrangement of objects on the home screen representations to the handheld device.

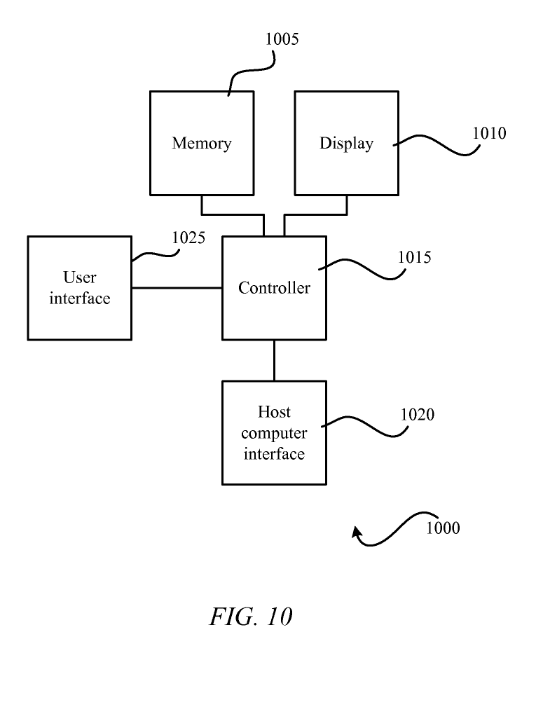

FIG. 10 shows a block diagram of a handheld device 1000. Handheld device 1000 can include memory 1005, a display 1010, controller 1015, host computer interface 1020, and user interface 1025. Various other components can also be included. Memory 1005 can store object and home screen configuration information. For example, memory 1005 can store icon/object graphic files, background image files, home screen configuration data, object configuration data, etc. Display 1010 can include any type of display that can display objects arranged on one or more home screens. In some embodiments, display 1010 can display objects on one or more home screens in a configuration that is stored in memory 1005. A user can move between home screens displayed on display 1010 by interacting with handheld device 1000 using user interface 1025. For example, the user can scroll between home screens using a trackball, touchpad, touch screen, buttons, remote control, etc. The user can also select objects displayed on display 1010 for execution via controller 1015 and/or display at display 1010 by selecting the object using the user interface. In some embodiments, user interface 1025 and display 1010 can be combined as a touch screen.

Handheld device 1000 can interact with a host compute using host computer interface 1020. For example, home screen and/or object configuration information can be communicated to and from host computer using host computer interface 1020. Controller 1015 can control display 1010 in response to user input from user interface 1025. For example, controller 1015 can open a document, display an image, execute an application, etc. in response to a selection of an object displayed on a home screen of display 1010 according to software stored in memory 1010.

It will be appreciated that the configurations and components described herein are illustrative and that variations and modifications are possible. A host computer and/or a handheld device may have other capabilities not specifically described herein. While a host computer and a handheld device described herein with reference to particular blocks, it is to be understood that the blocks are defined for convenience of description and are not intended to imply a particular physical arrangement of component parts. Further, the blocks need not correspond to physically distinct components.

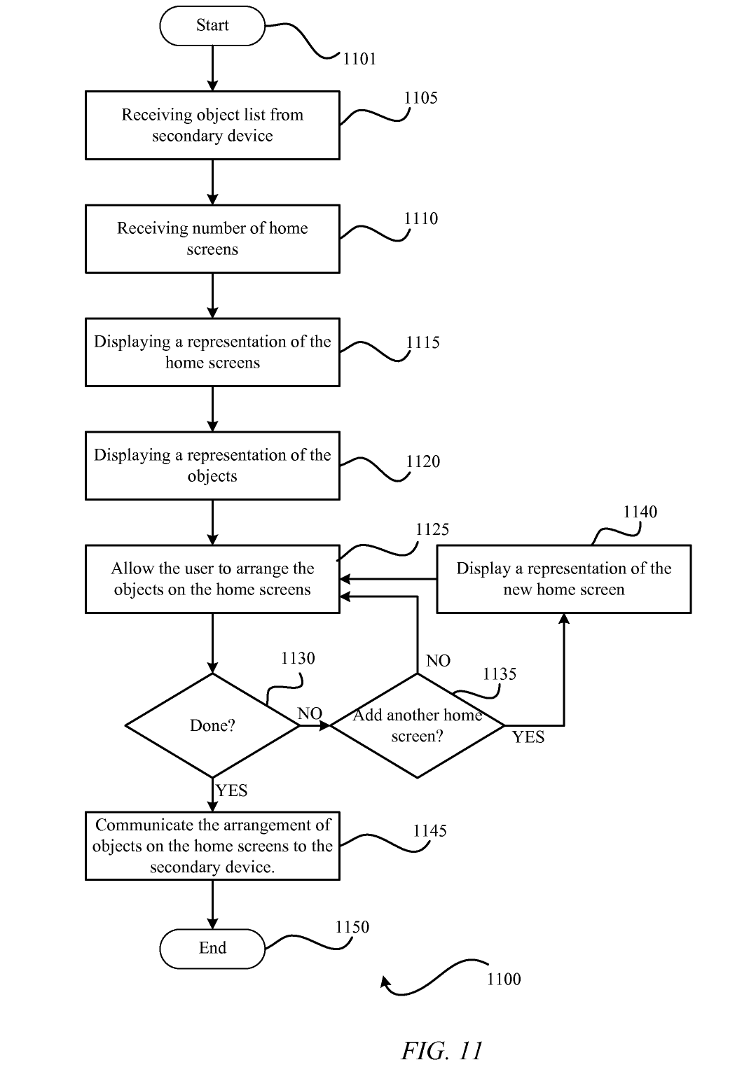

FIG. 11 shows a flowchart of a process 1100 for organizing objects on a home screen or home screens of a handheld device at a host computer according to some embodiments. Process 1100 starts at block 1101. At block 1105 the host computer can receive an object (or icon) list from a handheld device. In some embodiments, the object list can include a text string corresponding to the objects that can be displayed on a home screen. In some embodiments, the object list can include graphic images (e.g., icons) that represent each of the objects on the objects list. At block 1110 the host computer can receive an indication specifying the number of home screens currently defined at the handheld device. In some embodiment, the host computer can also receive an indication of the current layout of objects on the home screen(s) of the handheld device.

At block 1115 the host computer can display a representation of each of the host screens indicated by the handheld device. For example, if the handheld device indicates that four home screens are currently in use, then the host computer can display a representation of the four home screens. The host computer can also display a representation of each of the plurality of objects received from the handheld device at block 1120. In some embodiments, the host computer can display a graphical representation (e.g. an icon or user interface element) for each of the objects. The host computer, for example, can display the objects on the representation of home screen(s) as arranged on the handheld device (e.g., as shown in FIG. 2). As another example, the objects can be arranged separate from the representation of the home screen(s) (e.g., as shown in FIG. 6).

The host computer can then allow a user to arrange the objects on the representation of the home screens at block 1125. In some embodiments, the user can drag an object from one representation of a home screen to another representation of a home screen. In some embodiments, the user can drag an object from one location on a representation of a home screen to another location on the same home screen. The user can add objects to a representation of a home screen. When an object is added to a home screen representation, any application, document, and/or file associated with the object can also be sent to the handheld device. In some embodiments, the user can remove an object from a representation of a home screen. Various keyboard combinations, mouse movements, drag and drops, and/or gestures at or on a touch screen or touchpad can be used to move an object on, remove an object from, and/or add an object to a representation of a home screen.

In some embodiments, the user can indicate that the arrangement of objects on the representation of home screens is finished at block 1130. In some embodiments, the user can indicate completion by selecting a button on the display of the host computer. In some embodiments, the user can press a button or a combination of buttons on either the host computer or the handheld device. In some embodiments, the host computer can query the user to determine whether the arrangement is finished. In some embodiments, the host computer can consider the arrangement complete when a set period of idle time has elapsed. If the user does not indicate that the arrangement is complete, then process 1100 can proceed to block 1135.

In some embodiments, the user can choose to add another home screen to the handheld device at block 1135. If the user decides to add another home screen, then a representation of another home screen can be displayed at the host computer at block 1140. For example, if four home screens were displayed at the host computer, then a fifth home screen can be displayed. Process 1100 can then return to block 1125 where a user can be allowed to arrange objects on the displayed home screens. If another home screen is not added at block 1135, process 1100 can then return to block 1125.

If the user does indicate that the arrangement of objects among the representation of home screens is finished at block 1130, then an indication of the arrangement of objects on the representation of the home screen(s) can be sent to the handheld device at block 1145. After sending the indication of the arrangement to the handheld device, process 1100 can end at block 1150. The arrangement of objects can be sent all at once for all home screens or for each completed home screen separately.

In some embodiments, the host computer can provide an indication of the number of host screens upon which objects have been arranged. In some embodiments, the host computer can send arrangement information for each object. In some embodiments, the host computer can send an object identifier that identifies a specific object, the home screen where the object has been arranged, and coordinates indicating the location of the object on a home screen. In some embodiments, the coordinates can include a number corresponding to a known placeholder on the home screen. In some embodiments, the coordinates can include coordinates corresponding to orthogonal axes (e.g. (x, y, z) position relative to a corner or center of a display or home screen).

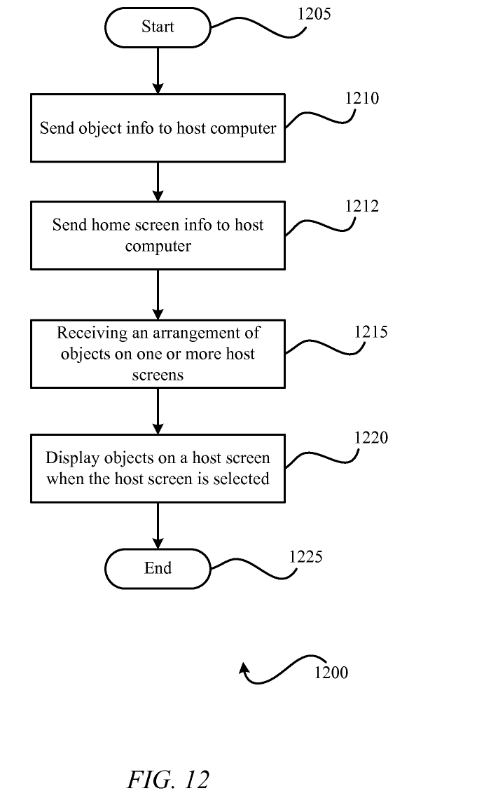

FIG. 12 shows a flowchart of a process 1200 for a handheld device to receive organized home screens from a host computer according to some embodiments. Process 1200 can start at block 1205. Object information can be sent to host computer at block 1210. Object information can include the number of objects to be displayed among home screens, an identifier for each object, an icon for each object, the present location (e.g. coordinates) of each object, etc. In some embodiments, at block 1212 the handheld device can send the current number of home screens to the host computer. The handheld device can then receive arrangement information from a host computer, specifying an arrangement of the objects among one or more home screens at block 1215. In some embodiments, the handheld device can receive an object identifier that identifies a specific object, the home screen where the object should be displayed, and coordinates indicating the location of the object on a home screen. In some embodiments, the coordinates can include a number corresponding to a known placeholder (or predetermined location) on a home screen. In some embodiments, the coordinates can include coordinates corresponding to orthogonal axes. In some embodiments, the coordinates can include a number corresponding to a known home screen.

The objects can then be displayed according to the arrangement received from the host computer at block 1220. At block 1225, process 1200 ends.

A host computer can also arrange other features of a view and/or a home screen of a handheld device. For example, a home screen background image, pattern or color can be provided on a home screen representation, and the background image can be sent to the handheld device along with the configuration information for the home screen. Moreover, a color pallet for a home screen or home screens can be selected, a font scheme including font size and type for a home screen or home screens can be selected, and/or a skin for a home screen or home screens can be selected at the host device. An indication of such selections can be sent to the handheld device.

It will be appreciated that processes 1100 and 1200 are illustrative and that variations and modifications are possible. Steps described as sequential may be executed in parallel, order of steps may be varied, and steps may be modified, combined, added or omitted. Moreover, while processes 1100 and 1200 have been described in relation to home screens at a handheld device, the processes can easily extend to views.

While the invention has been described with respect to specific embodiments, one skilled in the art will recognize that numerous modifications are possible. Circuits, logic modules, processors, and/or other components may be described herein as being “configured” to perform various operations. Those skilled in the art will recognize that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

While various embodiments have been described herein with reference to particular blocks, it is to be understood that the blocks are defined for convenience of description and are not intended to imply a particular physical arrangement of component parts. Further, the blocks need not correspond to physically distinct components.

While the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded on various computer readable storage media; suitable media include magnetic disk or tape, optical storage media such as compact disk (CD) or digital versatile disk (DVD), flash memory, and the like. Computer readable storage media encoded with the program code may be packaged with a compatible device or provided separately from other devices. In addition program code may be encoded and transmitted via wired optical, and/or wireless networks conforming to a variety of protocols, including the Internet, thereby allowing distribution, e.g., via Internet download.

Thus, although the invention has been described with respect to specific embodiments, it will be appreciated that the invention is intended to cover all modifications and equivalents within the scope of the following claims.

What is claimed is:

1. A method for configuring a user interface of a handheld device at a host device, the method comprising:
identifying, at the host device, a plurality of objects to display on the handheld device, wherein the plurality of objects can be displayed at the handheld device in any one of a plurality of arrangements;
organizing, at the host device, in response to user input, at least a subset of the plurality of objects in an arrangement representative of the user interface of the handheld device; and
communicating the display arrangement to the handheld device from the host device.

2. The method according to claim 1, wherein the representation of the user interface of the handheld device includes one or more windows.

3. The method according to claim 1, wherein the representation of the user interface of the handheld device includes one or more home screens.

4. The method according to claim 1, wherein the plurality of objects include a plurality of icons.

5. The method according to claim 1, wherein at least some of the plurality of objects represent applications executable at the handheld device.

6. The method according to claim 1, wherein at least some of the plurality of objects represent files accessible at the handheld device.

7. A computer-readable medium containing program instructions that, when executed by a processor of a host computer, cause the processor to execute a method comprising:
displaying at the host computer a representation of one or more views, each representation corresponding to a handheld device view;
displaying a plurality of icons on the display coupled with the host computer, wherein the icons are displayable in various configurations at the one or more views of the handheld device;
receiving user input arranging one or more icons with a representation of one or more views into an arrangement of icons; and
communicating the arrangement of icons to the handheld device.

8. A computer program product according to claim 7, wherein the method further comprises displaying an additional view and receiving user input arranging one or more icons with a representation of the additional view.

9. A computer program product according to claim 7 wherein the method further comprises receiving information from the handheld device identifying icons displayable at the handheld device.

10. A method comprising:
receiving, at a host computer, an indication of a plurality of icons available for display at a handheld device;
displaying, at the host computer, a representation of the plurality of icons;
displaying, at the host computer, a representation of a first view of the handheld device and a representation of a second view of the handheld device;
providing, at the host computer, a user interface that allows a user to arrange the representation of the plurality of icons among the representation of the first view and the representation of the second view into an icon arrangement; and
communicating the icon arrangement to the handheld device.

11. The method according to claim 10, further comprising displaying at the host computer a representation of a third view of the handheld device.

12. The method according to claim 11, wherein the act of providing includes providing a user interface that allows the user to arrange the representation of the plurality of icons among the representation of the first view, the representation of the second view, and the representation of the third view into an icon arrangement.

13. A method for use on a handheld device, the method comprising:
providing, to a host computer, an indication of objects that are displayable on one or more home screens of the handheld device;
receiving, from the host computer, an indication of an arrangement of the objects on a first home screen and a second home screen;
displaying the objects on the first home screen in accordance with the received indication of an arrangement of objects when the first home screen is selected by a user of the handheld device; and
displaying the objects on the second home screen in accordance with the received indication of an arrangement of objects when the second home screen is selected by a user of the handheld device.

14. The method according to claim 13, wherein the objects comprise icons.

15. The method according to claim 13, further comprising
receiving an indication of an arrangement of the objects on a third home screen; and
displaying the objects on the third home screen in accordance with the received indication of an arrangement of objects when the third home screen is selected by a user of the handheld device.

16. The method according to claim 13, wherein the handheld device comprises a phone.
